(19) United States
(12) Patent Application Publication
(10) Pub. No.: US 2014/0353452 A1
(43) Pub. Date: Dec. 4, 2014

(54) Extendable Pillar

(71) Applicant: Winvic Sales Inc., Markham (CA)

(72) Inventors: Donna Baker Schwenk, Rockport, MA (US); Pierre-Marc Tardy, Montreal (CA)

(21) Appl. No.: 13/908,787

(22) Filed: Jun. 3, 2013

(51) Int. Cl. F16M 11/28

(52) U.S. Cl. CPC F16M 11/28
USPC 248/404; 248/161; 248/414

(57) ABSTRACT

The present technology provides an extendable pillar having a lower section with a base column, and an upper section with an upper column. The base column includes a ratchet mechanism that operates with a fastener rod in the upper column. When the ratchet mechanism is in a locked position, the position of the upper section is fixed. When the ratchet mechanism is in an open position, the upper section can slide along the base column to extend or compress the length of the pillar. In certain embodiments, the upper column and the base column include friction connection mating components. The friction connection mating components cooperate to allow the upper section to slide along the base column when a sufficient force is applied to the upper section, while supporting the upper column at a fixed position when the force is removed.

### RELATED APPLICATIONS

Not Applicable

### BACKGROUND

Decorative pillars can be used to display a variety of ornamental or aesthetic objects. For example, decorative pillars can be used to support, hold, or display candles, flowers, photographs, statues, art work, or other decorative objects. Decorative pillars may come in a variety of sizes, shapes and configurations, and often have an ornamental or aesthetically pleasing appearance.

It may be desirable to use decorative pillars of a variety of shapes, sizes and/or appearance. For example, seasonal changes, decorating trends, the demands of various holidays or family events, and even a user's whim can invite a desire for a new or modified decorative pillar. Moreover, the size, shape, and type of object displayed on the pillar may generate a desire to modify the size and shape of the pillar. For example, it may be aesthetically pleasing to display a short candle on a shorter pillar, while a larger candle may be more aesthetically pleasing displayed upon a taller pillar. In order to utilize such a variety of pillar shapes and sizes, objects can be displayed on a variety of separate distinctive pillars. However, using a variety of distinctive pillars to display a variety of objects can be undesirable because it requires a user to possess a wide array of decorative pillars, to separately store the unused pillars, and to interchange the pillars whenever a display is changed.

### SUMMARY

The present technology provides an extendable pillar. In certain embodiments, the extendable pillar includes an upper section and a lower section. The lower section can include a base and a base column that extends from the base. The base column comprises an exterior surface, and can also include a ratchet mechanism. The upper section can include a platform and an upper column extending from the platform. In certain aspects of the present technology, the upper column can have an exterior surface and a fastener rod, which fastener rod may be located in an interior portion of the upper column. The ratchet mechanism operates with the fastener rod such that the position of the upper section is fixed with respect to the lower section when the ratchet mechanism is in a locked position, and such that the upper section is slidable slide along a longitudinal axis of the extendable pillar when the ratchet mechanism is in an open position.

In certain embodiments, the present technology provides an extendable pillar including a lower section with a base and a base column extending from the base. The base column includes an exterior surface that has a non-linear shape about the longitudinal axis of the base column. The base column also includes a collar having a ratchet mechanism, which ratchet mechanism can have one or more notches. The extendable pillar also includes an upper section that includes a platform and an upper column extending from the platform. The upper column includes an exterior surface with a non-linear shape about the longitudinal axis of the upper column. The upper column also includes an interior portion, which interior portion includes a fastener rod. The fastener rod has ridges arranged in a helical configuration about a longitudinal axis of the fastener rod. In certain embodiments, the ratchet mechanism can turn to a locked position so that the notches of the ratchet mechanism are engaged with at least one of the ridges of the fastener rod, and the ratchet mechanism can turn to an open position so that the notches of the ratchet mechanism are disengaged from the ridges of the fastener rod. The position of the upper section is fixed with respect to the lower section when the ratchet mechanism is in the locked position, and the upper section can slide along a longitudinal axis of the extendable pillar when the ratchet mechanism is in the open position.

Certain aspects of the present technology also provide an extendable pillar including a lower section that includes a base and a base column extending from the base. The base column comprises an exterior surface and an interior portion, and the interior portion comprises a base mating component. The extendable pillar also has an upper section with a platform and an upper column that extends from the platform. The upper column includes an exterior surface and an interior portion, and the interior portion includes an upper mating component. The upper mating component cooperates with the base mating component such that the upper section is slidable along a longitudinal axis of the extendable pillar. In certain embodiments, the upper mating component and the base mating component form a friction connection. The friction connection allows the upper section to slide along the longitudinal axis of the extendable pillar when a sufficient force is applied to the upper section. The friction connection is also capable of supporting the upper section at a fixed position with respect to the lower section when the sufficient force is removed.

### BRIEF DESCRIPTION OF THE DRAWINGS

FIG. 1 depicts an extendable pillar in accordance with at least one embodiment of the present technology.

FIG. 2 depicts an extendable pillar with an upper column removed in accordance with at least one embodiment of the present technology.

FIG. 3 depicts an upper section of an extendable pillar in accordance with at least one embodiment of the present technology.

FIG. 4 is a close up view of a fastener rod component of an extendable pillar in accordance with at least one embodiment of the present technology.

FIG. 5 is a close up view of a ratchet mechanism of an extendable pillar in accordance with at least one embodiment of the present technology.

FIG. 6 depicts a lower section of an extendable pillar in accordance with at least one embodiment of the present technology.

FIG. 7 depicts a cross-sectional view of an extendable pillar in a compressed position in accordance with at least one embodiment of the present technology.

FIG. 8 depicts a cross-sectional view of an extendable pillar in a partially extended position.

FIG. 9A depicts an extendable pillar displaying an electronic candle in accordance with at least one embodiment of the present technology.

FIG. 9B depicts an underside of a base of the extendable pillar of FIG. 9A in accordance with at least one embodiment of the present technology.

FIG. 10 depicts another embodiment of an extendable pillar with an upper column removed.

FIG. 11 depicts an upper section of the extendable pillar of FIG. 10.

FIG. 12 is a close up view of a fastener rod component of the extendable pillar of FIG. 10.

FIG. 13 is a close up view of a sleeve of the extendable pillar of FIG. 10.

FIG. 14 depicts a cross-sectional view of the extendable pillar of FIG. 10 in a compressed position.

FIG. 15 is a flow diagram for a method in accordance with at least one embodiment of the present technology.

### DETAILED DESCRIPTION

The present technology relates to decorative pillars. More specifically, the present technology relates to decorative pillars that are extendable and capable of operating at more than one length or height level. Various aspects of the present technology provide systems and methods that allow a user to extend a pillar to a desired height level, fix the pillar at a chosen height, and use the pillar for its intended purpose, for example, as a decorative stand or holder.

In certain situations, it may be desirable to modify the length or height of a decorative pillar. For example, a user may find it more aesthetically pleasing to display a short candle on a relatively short pillar, and a larger candle on a relatively tall pillar. Additionally and/or alternatively, in certain situations a user may find it desirable to arrange multiple pillars together so that each pillar is at a different height level in order to provide a tiered or multi-dimensional look.

It can be difficult, however, to provide an adjustable or extendable pillar that is also capable of maintaining an ornamental and aesthetically pleasing appearance. That is because, in order for a pillar to be extendable by way of telescoping functionality, the pillar will need to be broken into multiple sections that are capable of fitting inside one another. That is, the maximum outer diameter of an inner telescoping pillar section cannot be larger than the minimum inner diameter of any outer telescoping pillar section. For aesthetic reasons, however, decorative pillars often have a non-linear, cylindrical shape. Such a non-linear cylindrical shape often results in a pillar (or pillar section) having a maximum outer diameter that is significantly larger than its minimum inner diameter. As a result, a telescoping extendable pillar with an ornamental shape will likely have two or more pillar sections that have substantially different diameters and thicknesses. But a decorative pillar that employs multiple sections with substantially different diameters may not be aesthetically pleasing. For example, the step-down between a larger diameter upper pillar section and a smaller diameter lower pillar section can create a discontinuous, fragmented appearance that negatively impacts the ornamental and aesthetic qualities of the pillar. The present technology, however, provides embodiments of a new and useful extendable pillar that is capable of maintaining an ornamental and aesthetically pleasing appearance at a variety of pillar height levels.

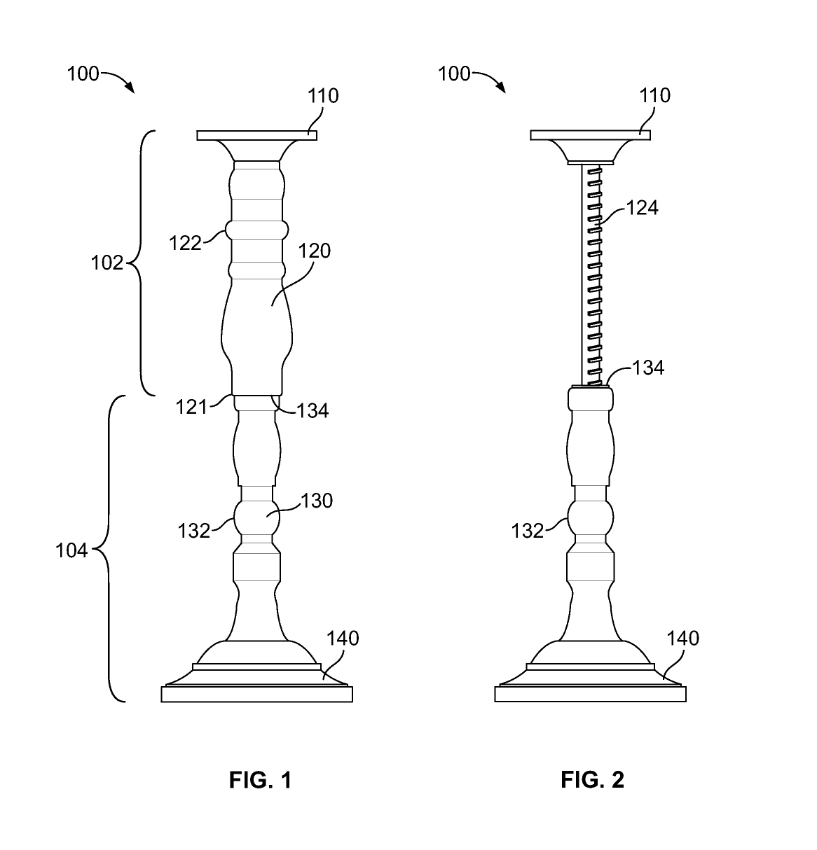

FIG. 1 depicts an extendable pillar 100 in accordance with at least one embodiment of the present technology. In particular, FIG. 1 depicts the exterior of an extendable pillar 100. The extendable pillar 100 comprises an upper section 102 and a lower section 104. The height of the extendable pillar 100 can be adjustable such that the upper section 102 can slide up and down with respect to the lower section 104, and become fixed at a particular position.

The upper section 100 comprises a platform 110, which can be used to support, hold, or display a variety of objects, such as candles, electronic candles, art, photographs, flowers, pottery, glassware or other decorative objects, for example. The platform 110 may include a flat surface, so that an object can be easily balanced thereupon. In certain embodiments, the platform may include clips, latches, slots, grooves, or other fastening or mating mechanisms to help assure that objects placed on the platform stay balanced thereupon. The platform 110 may be round, cylindrical, or any of a variety of other shapes or sizes. For example, the platform 110 can have a square, diamond or octagonal shape to accommodate a variety of ornamental designs. In certain embodiments, the platform 110 may be a part of the upper column 120, for example, the top surface of the upper column 120. Alternatively, the platform 110 can be a separate component from the upper column 102 that is attachable and detachable from the upper column 102. In certain embodiments, the platform 110 may be attachable to an additional platform, so that the pillar 100 can accommodate objects having a variety of shapes sizes.

The upper section 102 of the extendable pillar 100 also includes an upper column 120. The upper column 120 generally extends downward from the platform 110. The upper column has an exterior surface 122 that may have a non-linear, generally cylindrical shape about the longitudinal axis of the upper column 120. For example, the upper column 120 may be a generally cylindrical shape with a diameter that increases and decreases along the length of the upper column 120 to provide an ornamental appearance. The upper column has a lower surface 121 opposite the platform 110 side of the column 120. The upper column 120 is generally hollow, and can include an interior portion. The interior portion of the upper column 120 has a minimum interior diameter at the narrowest cross section of the interior portion. The interior portion of the upper column 120 may be adapted to accommodate the base column 130 of the lower section 104 as the upper section 102 slides along the longitudinal axis of the extendable pillar 100. That is, the minimum interior diameter of the upper column is greater than the maximum outer diameter of the base column 130. In certain aspects of the present technology, the diameter at the lower surface 121 of the upper column 120 is the minimum interior diameter of the upper column 120. In this manner, lower surface 121 is the narrowest point on the upper column 120, thereby minimizing the size of the step-down between the upper column 120 and the base column 130. Minimizing this step-down can improve the aesthetic and ornamental quality of the extendable pillar.

The lower section 104 of the extendable pillar 100 may include a base 140 and a base column 130 that generally extends upward from the base 140. In certain embodiments, the base 140 can be a part of the base column 130, however, in alternative embodiments, the base column 130 can be attachable to a base 140 that is a separate component. In certain embodiments, the base column 130 can be attachable to one or more other columns that provide ways to further extend the pillar 100. The base column 130 can have an exterior surface 132 that may have a non-linear, generally cylindrical shape. For example, the base column 130 (like the upper column 120) can be of a generally cylindrical shape with a diameter that increases and decreases along the length of the base column 130 to provide an ornamental shape.

The base column 130 has a maximum diameter that corresponds to the widest cross section of the exterior surface 132. In order for the upper section 102 to slide freely along the lower section, the maximum diameter of the base column 130 must be less than the minimum interior diameter of the upper column 120. In certain embodiments, the maximum diameter of the exterior surface can be less than, but very close to minimum interior diameter of the upper column 120. In this manner, the upper column can be arranged so that the lower surface 121 of the upper column aligns with the widest portion of the base column, reducing and even minimizing the size of the step-down between the upper 120 and base columns 130.

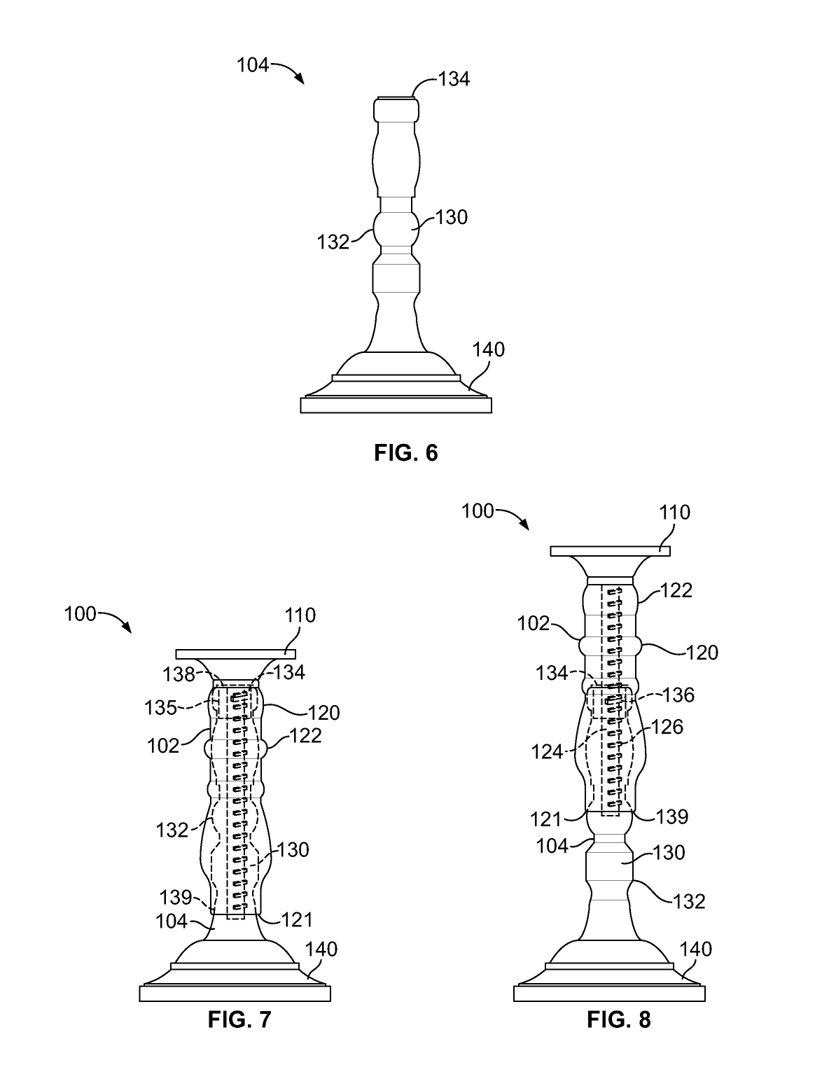

The base column 130 can also include a ratchet mechanism 134. The ratchet mechanism 134 can be, for example, a collar, located at an upper location of the base column 130. In certain embodiments, the ratchet mechanism 134 is a non-removable part of the lower section 104 and/or the base column 130. However, in other embodiments, the ratchet mechanism 134 can be a separate component that is capable of being installed and removed from the lower section 104, as described in further detail below and depicted in FIG. 6.

The base 140 may have a bottom surface that generally keeps the pillar 100 in an upright position. While the base 140 may be generally round or cylindrical in shape, the base 140 can take on a variety of other shapes. For example, the base 140 can be rectangular, octagonal, or triangular in shape to create a variety of ornamental looks. In certain embodiments, the base 140 can be attached or attachable to an additional wider base, for example, to provide additional structural and balancing support to the extendable pillar 100. In certain embodiments, the base 140 may be attachable to an additional column (e.g., another base column), thereby providing a greater range of extendibility of the pillar 100. In this manner the extendable pillar 100 need not be limited to two sections, or two columns, as generally referenced in this description. That is, in certain embodiments of the present technology, the extendable pillar 100 may include three or more columns, and/or three or more pillar sections that are capable of telescoping with respect to each other, such that the pillar can take on an even greater range of height levels.

FIG. 2 depicts the extendable pillar 100 with the upper column 120 removed, thereby showing internal components of the upper section 102. Specifically, FIG. 2 shows a fastener rod 124 as an internal component of the upper column 120. The fastener rod 120 can be connected to the platform 110, and operates with the ratchet mechanism 134 of the base column 130.

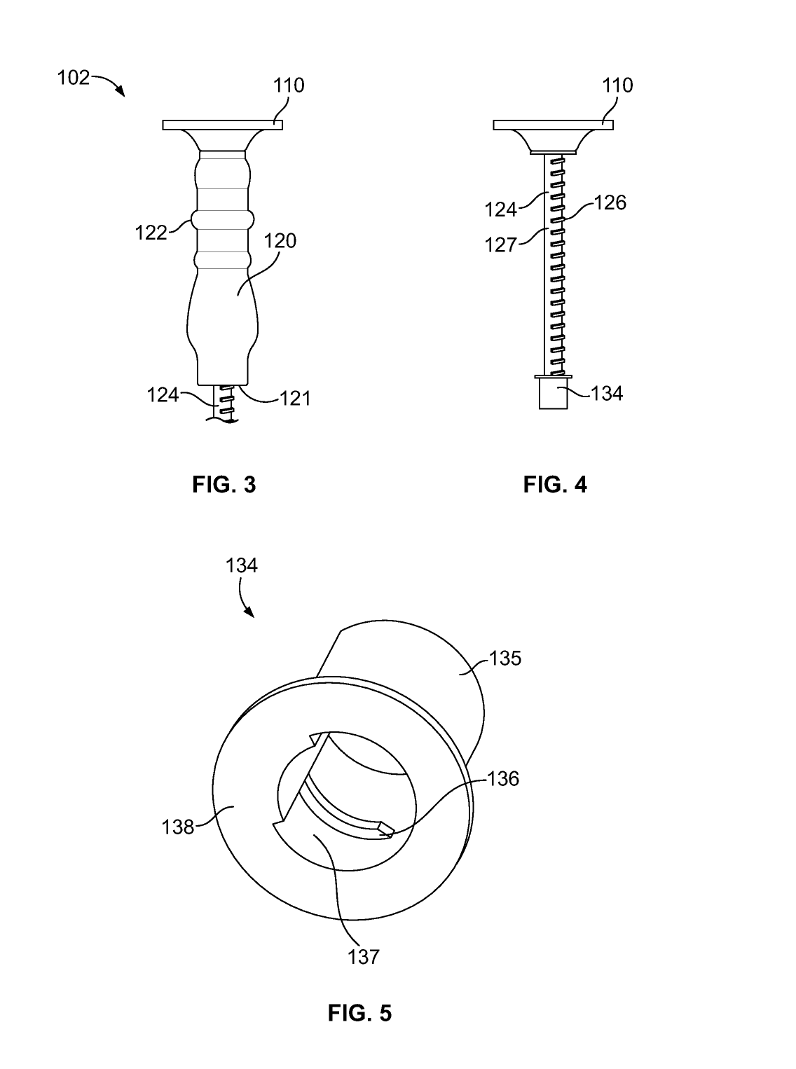

FIG. 3 shows the upper section 102 of the extendable pillar 100 separate from the lower section 104. In certain aspects of the present technology, the fastener rod 124 is located in an interior portion of the upper section 102, and extends just beyond the lower surface 121 of the upper column 120.

As shown in FIG. 4, the fastener rod 124 has a series of ridges 126 along the longitudinal axis of the fastener rod 124. In certain aspects, the ridges 236 are arranged in a broken helical configuration about a longitudinal axis of the fastener rod 124. In this manner a ridged portion of the fastener rod 124 will have ridges, while an un-ridged portion 127 will have no ridges. The distance between the ridges 126 can vary depending on the design of the rod. For example, in certain embodiments, the ridges 126 can be separated by about 3 mm. In certain embodiments, the ridges 126 can be thicker, and the distance between them greater to provide a higher degree of pillar strength. For example, in certain embodiments the ridges 126 can be separated by 4 or 5 mm. Additionally, in certain embodiments, for greater precision in the adjustability of the extendable pillar 100, the ridges can be separated by an even smaller distance, for example 2.5 mm or 2 mm.

The ridges 126 of the fastener rod 124 are adapted to operate in connection with the ratchet mechanism 134, which ratchet mechanism 134 is shown close up and in greater detail in FIG. 5. More specifically, the ridges 126 of the fastener rod 124 are adapted to engage with one or more notches 136, or teeth of the ratchet mechanism 134. The ratchet mechanism 134 can be a collar to the base column 130 that has a top surface 138 and one or more notches 136. The ratchet mechanism 134 can be designed so that a cylinder portion 135 of the ratchet mechanism 134 can fit inside of the base column 130, with a top surface 138 facing upwards, toward the upper column 120 of the extendable pillar 100.

The notch 136 or notches of the ratchet mechanism 134 are adapted to engage the ridges 126 of the fastener rod 124 when the ratchet mechanism 134 is in a locked position. In certain embodiments, the notches 136 of the ratchet mechanism 134 slide in between the ridges 126 of the fastener rod when the ratchet mechanism 134 is turned or rotated into a locked position. For example, the notches 136 can have a helical pattern, a partially-helical pattern, or an angled shape on the interior surface 137 of the cylinder portion 135 of the ratchet mechanism 134. In this manner, the ratchet mechanism 134 can be adapted to form a tight fit in between the ridges 126 of the fastener rod when the ratchet mechanism 134 is turned or rotated with respect to the upper section 102 (or, similarly, if the upper section 102 is turned or rotated with respect to the ratchet mechanism 134).

The lower section 104 and/or the ratchet mechanism 134 are configured to rotate with respect to the upper section to adjust the ratchet mechanism 134 between a locked position and an open position. For example, the lower section and/or the ratchet mechanism 134 can be rotated (e.g., 90 degrees in a clockwise direction from the open position) so that the notches 136 engage with the ridges 126 of the fastener rod 124, thereby establishing a locked position that inhibits or prevents movement of the upper section 102 with respect to the lower section 104. Likewise, the ratchet mechanism 134 can be turned (e.g., 90 degrees counter-clockwise from the locked position) to disengage from the ridges 126 of the fastener rod 124, thereby establishing an open position. When the ratchet mechanism 134 is in an open position, the notches 134 may be aligned with the un-ridged portion 127 of the fastener rod 124. Thus, when the ratchet mechanism 134 is in an open position, the upper section 102 and lower section 104 can move freely with respect to one another about the longitudinal axis of the extendable pillar 100. Accordingly, a user can extend the height of the pillar 100 by turning the ratchet mechanism 134 to an open position, sliding the upper section 102 to a desired position, and then turning the ratchet mechanism 134 back to a locked position. Moreover, because the notches 136 of the ratchet mechanism 134 and the ridges 126 of the fastener rod 124 can be arranged in a helical and/or angled, configuration the ratchet mechanism 134 and the fastener rod 124 can be adapted to establish a tight fit in the locked position. For example, such a tight fitting configuration can prevent the notches 136 from rotating beyond the ridges 126 and turning beyond a locked position.

FIG. 6 depicts a lower section 104 of an extendable pillar 100. As shown, the lower section 104 comprises the base 140, a base column 130 extending from the base 140, and a ratchet mechanism 134, which can be, for example, a collar to the base column 130. In certain embodiments, the ratchet mechanism 134 can be located at top portion of the base column 130 to provide for maximum extendibility of the pillar 100. In certain embodiments of the present technology, the ratchet mechanism 134 can be built into the lower section 104, or a part of the base column 130. In other embodiments, however, the ratchet mechanism 134 can be a separate component that is removable from the lower section 104 of the pillar 100.

The exterior surface 132 of the base column 130 has a non-linear cylindrical shape about the longitudinal axis of the base column that provides a decorative, ornamental appearance. In certain embodiments, shape of the base column 130 can be such that the exterior surface 132 has a maximum outer diameter at multiple locations. In this manner, the upper section 102 can be positioned such that the lower surface 121 of the upper column 120 can be aligned with a portion of the base column 130 that has a maximum outer diameter, or a near maximum outer diameter, thereby reducing and/or limiting the size of the step-down between the upper column 120 and the base column 130, and providing a generally aesthetically pleasing look.

FIG. 7 depicts a cross-sectional view of an extendable pillar in a compressed position. In FIG. 7, the ratchet mechanism 134 has been turned so that the ratchet 136 is engaged with the ridges 126 of the fastener rod 124, thereby establishing a locked position. Because the ratchet mechanism 134 of FIG. 7 is engaged with one of the top-most ridges 126 of the fastener rod 124, the extendable pillar 100 is in a compressed position. That is, the height of the extendable pillar 100 is at or near the minimum height. As shown in FIG. 7, the minimum inner diameter of the upper column 120 is greater than the maximum outer diameter of the base column 130, thereby allowing the base column 130 to fit within the upper column 120. Also as shown, the inner diameter of the upper column 120 at the lower surface 121 is a minimum or near-minimum diameter. In this compressed position, the lower surface 121 is generally aligned with a region 139 of the base column 130 where the outer diameter of the exterior surface 132 is at a maximum, or near maximum. Accordingly, in this embodiment, the step-down between the upper section 102 and the lower section 104 is minimal, and may be generally unnoticeable to the human eye.

The actual compressed and extended length of the extendable pillar 100 can vary depending on the design and implementation of the pillar 100. However, certain embodiments of the present technology provide an extendable pillar 100 that has a minimum height of about 9 inches when in a compressed position, and a maximum height of about 15 inches when in an extended position. The extendable pillar can then be adjusted to accommodate a plurality of heights between the minimum and maximum heights. For example, in certain partially-extended or partially-compressed positions, the pillar can be about 12 inches.

FIG. 8 depicts a cross-sectional view of an extendable pillar in a partially extended position. In FIG. 8, the ratchet mechanism 134 is engaged with the ridges 126 at a midpoint of the fastener rod 124, and is therefore in a partially-compressed (or partially-extended) position. Moreover, the lower surface 121 of the upper column is aligned with region 139 of the base column 130 where the outer diameter of the exterior surface 132 is at a maximum, or near maximum.

The Figures and the present description generally describe an extendable pillar 100 where the upper column 120 has a larger diameter than the base column 130, thereby allowing the lower column 130 to fit within the upper column 120. However, in certain embodiments, the upper column 120 can be narrower than the base column 130, such that the upper column 120 can fit within the base column 130 when the extendable pillar 100 is in a compressed state. In such an embodiment, the maximum outer diameter of the upper column 120 would be less than the minimum inner diameter of the base column 130. For example, in certain embodiments, the extendable pillar 100 of FIG. 1 can be provided upside-down, such that the platform 110 is attached to the base section 130, and the base 140 is attached to the upper column.

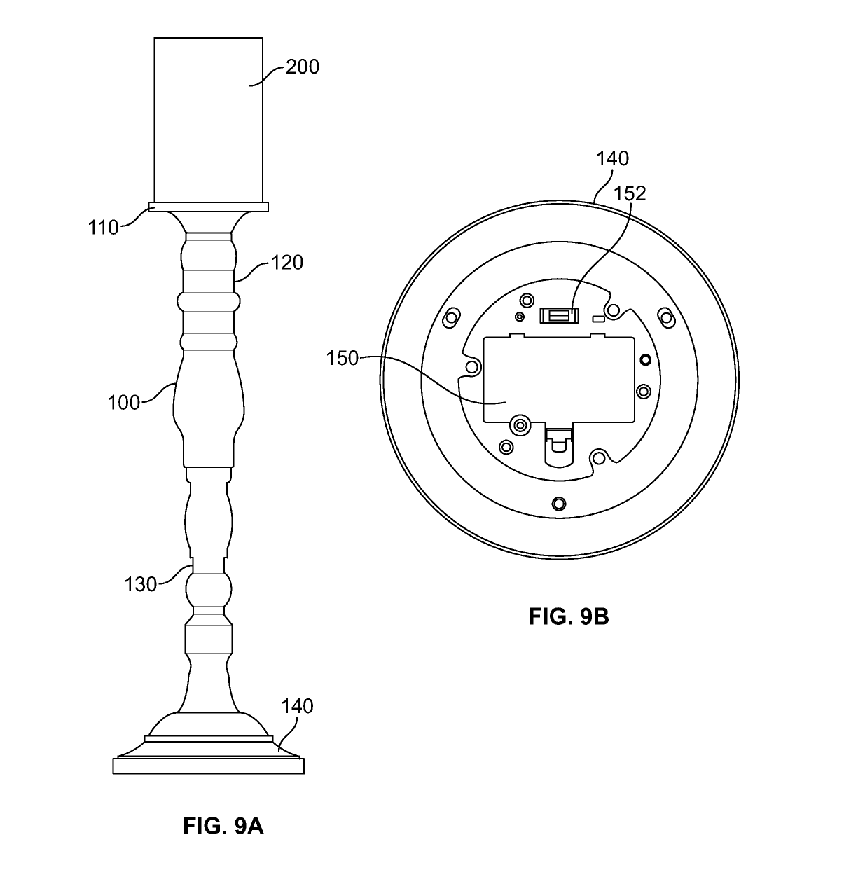

In certain aspects of the present technology, the extendable pillar 100 may be configured to display an electronic candle. FIGS. 9A and 9B depict exemplary embodiments of an extendable pillar 100 adapted to display an electronic candle 200. As shown in FIG. 9A, the electronic candle 200 can be displayed on the platform 110 of the extendable pillar 100. The electronic candle can be of a variety of shapes and sizes, and may be adapted to provide an aesthetically pleasing look when displayed on the extendable pillar 100. The electronic candle can include a wick or an electronic flame that resembles the appearance of an actual flame.

As shown in FIG. 9B, the base 140 of the extendable pillar 100 may include a battery compartment 150 that can house one or more batteries. The batteries can be used to provide electric power the electronic candle 200. In certain embodiments, the battery compartment 150 has electrical contacts arranged to contact batteries and form an electrical connection with the platform 110. The electronic connection can be provided via conductors, (e.g. wires) that run through the base column 130 and the upper column 120 to the platform 110, for example. In this manner, the battery compartment 150 can provide electric power to an electronic candle or other electronic device on the platform 110. The base 140 may also comprise a switch 152 that controls the electrical power from the one or more batteries in the battery compartment 150 to the electronic candle 200. In certain aspects, the switch can be located at various positions on or around the extendable pillar, for example, on the platform 110, or on the electronic candle 200.

In certain embodiments, the battery compartment 150 can be located in, or as a portion of the upper column 120. For example, the battery compartment can be located in the platform 110, or in an internal portion of the upper column. In this manner, the electronics can reside entirely within the upper portion 102 of the pillar 100, thereby alleviating a need to establish an electrical connection between the upper column 120 and the base column 130 of the extendable pillar 100.

Certain aspects of the present technology offer additional embodiments for providing an extendable pillar. For example, the present technology also includes embodiments that provide an extendable pillar using a friction connection. In the friction connection embodiment, the extendable pillar can have an upper section with a platform and an upper column, and a lower section with a base and a base column. In certain aspects, the interior portion of the upper column can be larger than the exterior of the base column so that the upper column can accommodate or receive the base column. Alternatively, the interior portion of the base column can be larger than the exterior of the upper column, so that the lower column can accommodate or receive the upper column. The exterior surface of both the base column and the upper column can have a non-linear shape about the longitudinal axis of the columns to provide an ornamental and aesthetically pleasing appearance.

The base column may have an interior portion with a base mating component, and the upper column may have an interior portion with an upper mating component. The upper mating component and the base mating component can cooperate such that the upper section is slidable along a longitudinal axis of the pillar 100. In certain aspects, the upper mating component and the base mating component may form a friction connection. For example, the upper mating component and the base mating component can be cylinders (e.g., steel cylinders), that are adapted to form a friction connection with one another. Additionally and/or alternatively, the mating components can include one or more of the following: rings, rods, pistons, or shafts, for example that slide within one another and generate friction between the components.

In the friction connection embodiment, one of the mating components can be a larger cylinder, while the other mating component is a smaller cylinder. The larger cylinder has an inner diameter that is adapted to accommodate, or receive the smaller cylinder. In certain embodiments, the upper mating component can be a larger cylinder that receives the smaller cylinder of the lower mating component. Alternatively, the lower mating component can be the larger cylinder that receives the smaller cylinder of the upper mating component. The inner diameter of the larger cylinder can be very close in size to the outer diameter of the smaller cylinder so that the mating components establish a snug-fitting friction connection therebetween. The friction connection can be such that the mating components allow the upper section to slide along the longitudinal axis of the pillar when a sufficient force (either an extending force or a compressing force) is applied to the upper section. That is, the sufficient force is greater than the force of friction established by the friction connection. Additionally, the friction connection can be strong enough to supporting the weight of the upper section and any objects displayed on the platform of the upper section at a fixed position when the sufficient force is removed.

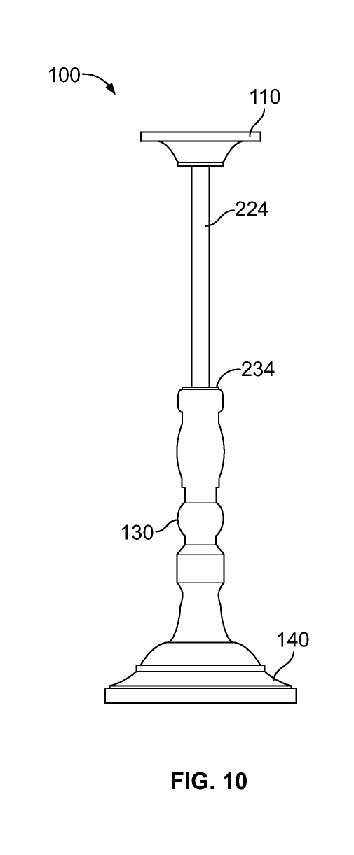

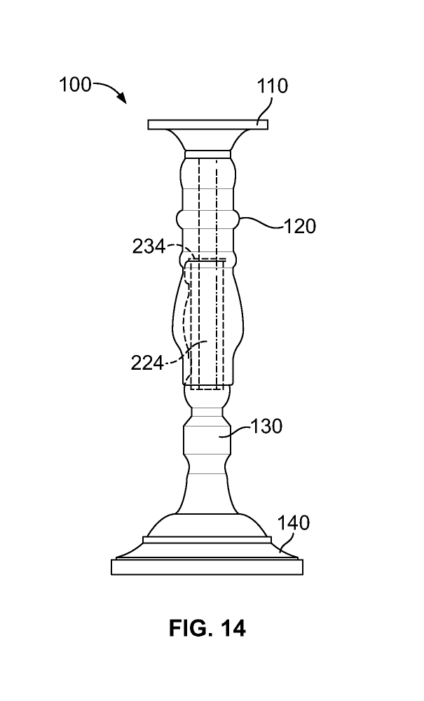

FIGS. 10-14 depict one or more embodiments of an extendable pillar using a friction connection. In these embodiments, the extendable pillar employs mating components that establish a friction connection without the use of the ridges and ratchet mechanism described with respect to FIGS. 1-9B.

FIG. 10 depicts an embodiment of an extendable pillar 100 with the upper column removed, thereby showing the internal components of the upper section of the pillar 100. Specifically, FIG. 2 shows a slider rod 224 as an upper mating component of the upper column. The slider rod 224 can be connected to the platform 110, and operates with a base mating component, sleeve mechanism 234 of the base column 130. As shown in FIG. 10, the slider rod 124 does not comprise any ridges, thereby allowing the slider rod 224 to slide up and down with respect to the base column 130 of the extendable pillar 100.

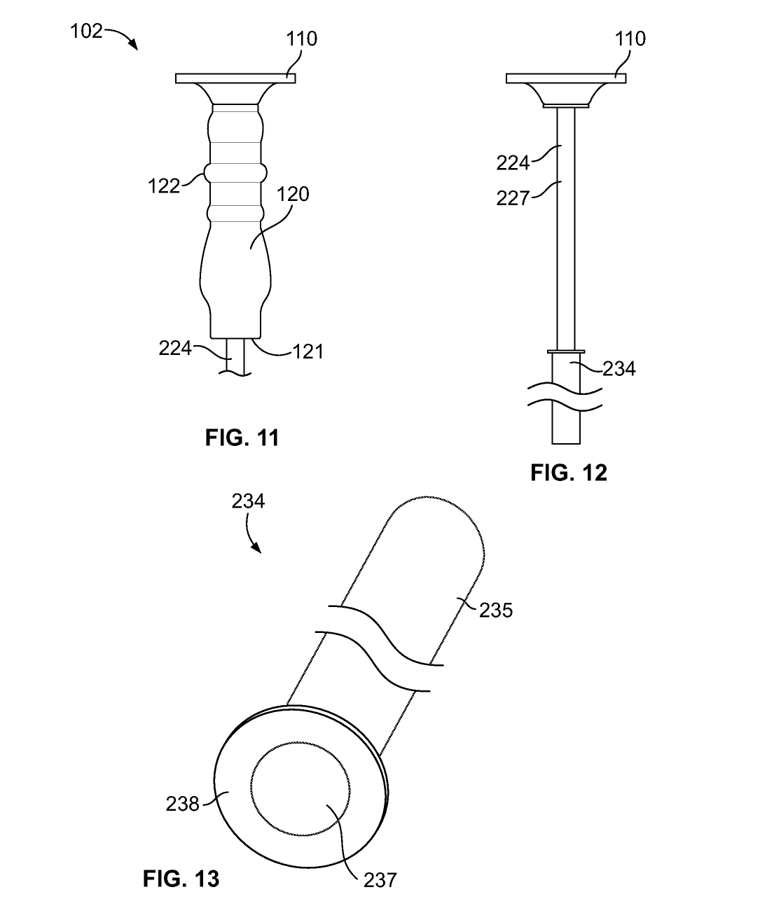

FIG. 11 shows the upper section 102 of the extendable pillar 100 separate from the lower section 104. In certain aspects of the present technology, the slider rod 224 is located in an interior portion of the upper section 102 of the extendable pillar, and extends just beyond the lower surface 121 of the upper column 120.

As shown in FIG. 12, the slider rod 224 has a smooth surface 227 along the longitudinal axis of the slider rod 224. The slider rod 224 is adapted to cooperate with a sleeve mechanism 234 of the lower column.

FIG. 13 depicts the sleeve 234, which may comprise a top surface 238 that faces toward the upper column 120 of the extendable pillar 100, and a sleeve cylinder 235 extending downward from the top surface 238. As shown in FIG. 13, the sleeve 234 has a smooth surface 237 on the interior of the sleeve cylinder 235. In this manner the slider rod 224 cooperates with the sleeve 234 of the base column to establish a friction connection. The length of the sleeve 234 can vary depending on the design and/or the desired level of friction between the slider rod 224 and the sleeve 234. For example, in certain embodiments, the sleeve 234 can have a length about half of the height of the base column 130. Alternatively, in certain embodiments, the length of the sleeve 234 can extend up to the height of the base column 130, or it can be of a length similar to that of the ratchet mechanism 134 depicted in FIGS. 4-5 and 7-8.

More specifically, the inner diameter of the sleeve cylinder 235 is slightly larger than the outer diameter of the slider rod 224, such that the slider rod 224 fits snugly within the sleeve 234, thereby establishing a friction connection. For example, in certain embodiments, the inner diameter of the sleeve 234 may be 0 to 2 mils greater than the outer diameter of the slider rod 224. In this manner, the slider rod 224 can still fit within the sleeve 234, while maintaining a relatively level of friction between the two components. Accordingly, the upper column 120 can move with respect to the lower column 130 when a sufficient force is applied in the longitudinal direction to the extendable pillar, when the sufficient force is great enough to overcome the friction between the two components. Additionally, the upper column 120 can remain in a fixed position with respect to the lower column 130 when the longitudinal force applied to the upper column 120, whether applied by a user or the weight of a displayed object, for example, is less than the sufficient force required to overcome the force of friction between the two components.

In certain embodiments, the sufficient force (i.e., the force required to cause the upper section and lower section to move with respect to one another) is greater than the combined weight of the upper section and any object that the pillar is designed to display, such as an electronic candle, for example. That is, the friction force between the upper and lower mating components is greater than the weight of the upper column plus the weight of any object the pillar is designed to display. Additionally, the sufficient force required to move the upper and lower sections with respect to one another can be low enough that a user can extend or compress the extendable pillar with relative ease. That is, the sufficient force should not require a significantly level of user strength to be able to extend or compress the extendable pillar. In certain embodiments, for example, the sufficient force can be around 20 N, or 4.5 lbs.

In the friction connection embodiments, a user can set the upper column of the extendable pillar can be set to any desired height level. Unlike the embodiments that employ a fastener rod with ridges and a ratchet mechanism, because the friction connection pillars are not dependent on ridges and a ratchet mechanism, it can be arranged at any height level without depend on the distance between the ridges. In this manner, a user can set the extendable pillar to a specific height without significant variance. For example, a user may arrange the upper column 120 so that the bottom (and narrowest) portion of the upper column aligns relatively precisely with a widest exterior portion of the base column. Additionally and/or alternatively, a user can arrange the pillar so that the platform aligns relatively precisely with the platform of another pillar that does not have an extendibility feature.

Like the extendable pillar embodiments that employ ridges and a ratchet mechanism depicted in FIG. 9B, the friction connection pillars may also include an electrical power source. For example, the base 140 of the extendable pillar 100 may include a battery compartment that can house one or more batteries. The batteries can be used to provide electric power an electronic candle or other lighting device. In certain embodiments, the battery compartment has electrical contacts arranged to contact batteries and form an electrical connection with the platform 110. In further embodiments, the battery compartment can be located in, or as a portion of the upper column 120. For example, the battery compartment can be located in the platform 110, or in an internal portion of the upper column of the friction connection extendable pillar.

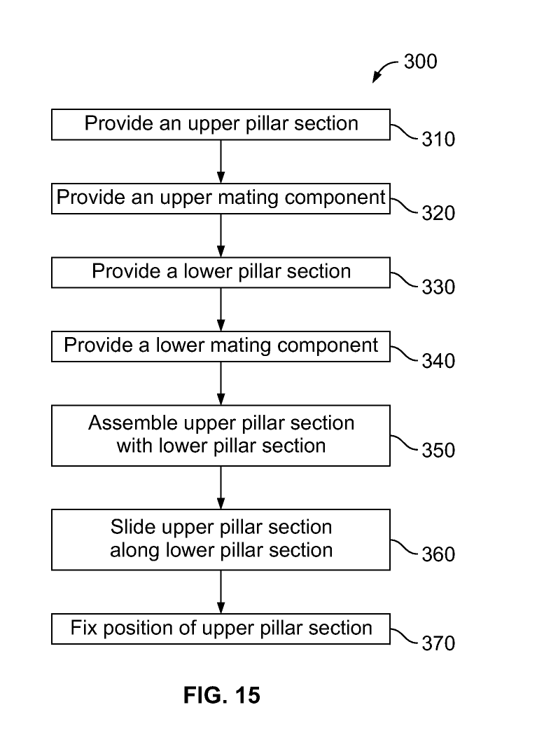

The present technology also provides methods for providing a pillar that can be extended to a variety of height levels. FIG. 15 is a flow diagram of a method 300 for providing an extendable pillar. The method includes the step 310 of providing an upper pillar section. This upper pillar section can include, for example, a platform and an upper column extending from the platform. The platform may include an object placed thereupon. For example, the platform may include an electronic candle as described in reference to FIGS. 9A and 9B.

The method also provides, at step 320, an upper mating component in the upper pillar section. The upper mating component can be, for example, a fastener rod as described in reference to FIGS. 1-8, or a mating component adapted to form a friction connection as described in reference to FIGS. 10-14.

At step 330, the method provides a lower pillar section. The lower pillar section can include, for example, a base and a base column extending from the base. In certain embodiments the base may include a battery compartment as described above in reference to FIGS. 9A and 9B. For example, the battery compartment may have electrical contacts arranged to contact batteries and form an electrical connection with the platform of the pillar. In this manner, the battery compartment can provide electric power to an electronic candle or other electronic device on the platform.

The method also provides, at step 340, a lower mating component in the lower pillar section. For example, the method can provide a ratchet mechanism in the base column and/or a removable collar installable in the lower pillar section. Alternatively, the method can provide a mating component adapted to form a friction connection with the corresponding mating component in the upper pillar section, such as a steel cylinder, for example.

The upper pillar section is assembled with the lower pillar section at step 350. For example, at step 350 the upper pillar section, including the upper mating component can be attached, installed on, or otherwise connected to the lower pillar section, including the lower mating component. In this step, the upper mating component and the lower mating component are mated together in a manner that allows the upper pillar section to move and/or slide with respect to the lower pillar section about a longitudinal axis of the extendable pillar.

At step 360, the upper pillar section slides along the lower pillar section. For example, at step 360 a user may slide the upper pillar section up or down along the lower pillar section to establish a taller or shorter pillar. In certain embodiments, for example, those embodiments that employ a fastener rod and a ratchet mechanism, a user may twist, turn or rotate one of the upper pillar section, the lower pillar section or the ratchet mechanism to disengage the upper and lower mating components, thereby allowing the upper pillar section and lower pillar section to freely move with respect to one another. In other embodiments, for example, those embodiments that employ a friction connection, a user may apply a sufficient extension or compression force to slide the upper pillar section with respect to the lower pillar section.

Next, the position of the upper pillar section is fixed at step 370. In embodiments that employ a fastener rod and a ratchet mechanism, a user may twist, turn or rotate one of the upper pillar section, the lower pillar section or the ratchet mechanism so that the ratchet mechanism is in a locked position. For example, a user may rotate the ratchet mechanism to a position where the notches of the ratchet mechanism are engaged with the ridges of the fastener rod, thereby fixing the position of the upper pillar section with respect to the lower pillar section. Alternatively, in embodiments that employ a friction connection, a user can fix the position of the upper pillar section by removing the sufficient force, i.e., the force necessary to overcome the force of friction between the mating components. In this manner, the position of the upper pillar section can remain fixed with respect to the lower pillar section by the force of friction between the upper and lower mating components.

The present technology provides pillars that are extendable by way of a variety of methods and techniques. The present technology can be implemented in pillars that provide electrical power in order to provide lighting or other decorative display functionality. However, it is also recognized that the present technology can be applied in a manner that is not limited to the designs, styles and types of pillars described and depicted herein. For example, the present technology can be applied to pillars that have a wide range of diameters. That is, the present technology can be applied to tapers (i.e., thin dinner candle holders) or other pillars that are relatively narrow (e.g., an inch or less). The present technology can also be applied to pillars that are relatively wide (e.g. greater than one foot), such as pedestals or platforms used to display statues or other large objects. The present technology can also be applied to pillars made of a variety of materials, such as plastic, metal, wood, glass, or ceramic, for example.

The present technology describes extendable pillars that can be used for decoration and display in the home or an indoor environment; however, the present technology can also be applied to pillars and posts that can be used outdoors. For example, the present technology can be to garden posts our outdoor lamps.

The present technology can also be implemented in a variety of other household devices or equipment. For example, the extendable pillar technology described herein can be implemented as legs for a table, a chair, a bed, a sofa or other furniture. The present technology could also be applied in a variety of lighting or electronic equipment. For example, the present technology can be applied in lamps, where the extendable pillar is the base of a lamp, and in wall-mounted sconces, where the extendable pillar extends upwards and/or outwards from the base of the sconce. In certain embodiments, the present technology can provide extendable pillars used in a ceiling-mounted hanging chandelier. For example, the extendable pillar may extend downward from the ceiling, as opposed to upwards as depicted in FIGS. 1-14. The present technology could also be applied in outdoor lighting and/or spot lighting, for example. The present technology can also be incorporated into lighting equipment that utilizes a variety of lighting methods. For example, the present technology can be applied to lighting equipment that uses battery operated power, solar power or AC power.

The present technology has now been described in such full, clear, concise and exact terms as to enable any person skilled in the art to which it pertains, to practice the same. It is to be understood that the foregoing describes preferred embodiments and examples of the present technology and that modifications may be made therein without departing from the spirit or scope of the invention as set forth in the claims. Moreover, it is also understood that the embodiments shown in the drawings, if any, and as described above are merely for illustrative purposes and not intended to limit the scope of the invention. As used in this description, the singular forms “a,” “an,” and “the” include plural reference such as “more than one” unless the context clearly dictates otherwise. Further, all references cited herein are incorporated in their entirety.

1. An extendable pillar comprising:
a lower section including a base and a base column extending from the base, the base column comprising an exterior surface and a ratchet mechanism; and
an upper section including a platform and an upper column extending from the platform, the upper column comprising an exterior surface and a fastener rod;
wherein the ratchet mechanism operates with the fastener rod such that the position of the upper section is fixed with respect to the lower section when the ratchet mechanism is in a locked position, and wherein the upper section is slidable with respect to the base column when the ratchet mechanism is in an open position.

2. The extendable pillar of claim 1, wherein the fastener rod comprises ridges that operate in connection with one or more notches of the ratchet mechanism.

3. The extendable pillar of claim 2, wherein the one or more notches engage the ridges of the fastener rod when the ratchet mechanism is in a locked position.

4. The extendable pillar of claim 2, wherein the ridges are arranged in a helical configuration about a longitudinal axis of the fastener rod.

5. The extendable pillar of claim 2 wherein the ridges of the fastener rod are separated by about 4 mm.

6. The extendable pillar of claim 1, wherein the ratchet mechanism comprises a collar at an upper location of the base column.

7. The extendable pillar of claim 1 wherein the ratchet mechanism rotates with respect to the upper section to adjust the ratchet mechanism between the locked position and the open position.

8. The extendable pillar of claim 1 wherein the upper column comprises an interior portion adapted to accommodate the base column of the lower section as the upper section slides along a longitudinal axis of the extendable pillar.

9. The extendable pillar of claim 8, wherein the exterior surface of the base column has a non-linear shape about a longitudinal axis of the base column, and wherein the exterior surface of the upper section has a non-linear shape about a longitudinal axis of the upper column.

10. The extendable pillar of claim 9, wherein the interior portion of the upper column has a minimum inner diameter and the base column has a maximum outer diameter, wherein the minimum inner diameter of the upper column is greater than the maximum outer diameter of the base column.

11. The extendable pillar of claim 1, wherein the base comprises a battery compartment electrically connected with the platform.

12. The extendable pillar of claim 1, wherein height the pillar is at least 15 inches when in an extended position.

13. The extendable pillar of claim 12, wherein the height of the pillar is about 9 inches when in a compressed position.

14. An extendable pillar comprising:
a lower section including a base and a base column extending from the base, the base column comprising:
an exterior surface including a non-linear shape about a longitudinal axis of the base column; and
a collar comprising a ratchet mechanism, the ratchet mechanism comprising one or more notches; and
an upper section including a platform and an upper column extending from the platform, the upper column comprising:
an exterior surface including a non-linear shape about a longitudinal axis of the upper column; and
an interior portion comprising a fastener rod, the fastener rod comprising ridges arranged in a helical configuration about a longitudinal axis of the fastener rod;
wherein the ratchet mechanism is in a locked position when the notches of the ratchet mechanism are engaged with at least one of the ridges of the fastener rod, wherein the ratchet mechanism is in an open position when the notches of the ratchet mechanism are disengaged from the ridges of the fastener rod, and
wherein the position of the upper section is fixed with respect to the lower section when the ratchet mechanism is in the locked position, and wherein the upper section can slide along a longitudinal axis of the extendable pillar when the ratchet mechanism is in the open position.

15. An extendable pillar comprising:
a lower section including a base and a base column extending from the base, the base column comprising an exterior surface and an interior portion, the interior portion of the base column comprising a base mating component; and
an upper section including a platform and an upper column extending from the platform, the upper column comprising an exterior surface and an interior portion, the interior portion of the upper column comprising an upper mating component;
wherein the upper mating component cooperates with the base mating component such that the upper section is slidable along a longitudinal axis of the extendable pillar.

16. The extendable pillar of claim 15, wherein the upper mating component and the base mating component together form a friction connection, and wherein the friction connection allows the upper section to slide along the longitudinal axis of the extendable pillar when a sufficient force is applied to the upper section.

17. The extendable pillar of claim 16, wherein the friction connection is configured to support the upper section at a fixed position with respect to the lower section when the sufficient force is removed.

18. The extendable pillar of claim 15, wherein at least one of the upper mating component and the base mating component comprises a sleeve having an inner diameter, and wherein at least one of the upper mating component and the base mating component comprises a slider rod having an outer diameter, wherein the inner diameter of the sleeve is adapted to accommodate the outer diameter of the slider rod.

19. The extendable pillar of claim 15, wherein the upper column is adapted to accommodate the base column as the upper section slides with respect to the base section.

20. The extendable pillar of claim 19, wherein the exterior surface of the base column has a non-linear shape about a longitudinal axis of the base column, and the exterior surface of the upper column has a non-linear shape about a longitudinal axis of the upper column.
